(19) United States
(12) Patent Application Publication
(10) Pub. No.: US 2021/0065135 A1
(43) Pub. Date: Mar. 4, 2021

(54) ELECTRONIC SYSTEM WITH CALENDAR MECHANISM AND METHOD OF OPERATION THEREOF

(71) Applicant: Catchup Calendar Inc., Milpitas, CA (US)

(72) Inventor: Vamshi Krishna Maringanti, Milpitas, CA (US)

(21) Appl. No.: 16/557,793

(22) Filed: Aug. 30, 2019

(51) Int. Cl. G06Q 10/10; H04M 1/725

(52) U.S. Cl. CPC G06Q 10/1095; H04M 1/72522

(57) ABSTRACT

A method of operation of an electronic system includes: operating a calendar application; generating a calendar invite with a phone number; and transmitting the calendar invite with the phone number.

### CROSS-REFERENCE TO RELATED APPLICATION

This application contains subject matter related to a concurrently filed U.S. Provisional patent application by Vamshi Krishna Maringanti titled “ELECTRONIC SYSTEM WITH CALENDAR MECHANISM AND METHOD OF OPERATION THEREOF.” The related U.S. Provisional Patent Application is assigned to Catchup Calendar Inc. and is identified by Application No. 62/894,510 filed Aug. 30, 2019. The subject matter thereof is incorporated herein by reference thereto.

### TECHNICAL FIELD

The present invention relates generally to an electronic system and more particularly to a system for electronic system with calendar mechanism.

### BACKGROUND ART

Modern portable consumer and industrial electronics, especially client devices such as electronic systems, cellular phones, portable digital assistants, and combination devices, are providing increasing levels of functionality to support modern life including calendar services. Numerous calendar applications place burdens for the user have become a paramount concern for consumers. Research and development in the existing technologies can take a myriad of different directions.

Thus, a need still remains for an electronic system that can schedule meetings and events with reasonable ease. In view of increasing demand for better time management, it is increasingly critical that answers be found to these problems. In view of the ever-increasing commercial competitive pressures, along with growing consumer expectations and the diminishing opportunities for meaningful product differentiation in the marketplace, it is critical that answers be found for these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### DISCLOSURE OF THE INVENTION

The present invention provides a method of operation of an electronic system including: operating a calendar application; generating a calendar invite with a phone number; and transmitting the calendar invite with the phone number.

The present invention provides an electronic system including: a control circuit configured to: operate an calendar application; generate a calendar invite with a phone number; transmit the calendar invite with the phone number; and a communication circuit, coupled to the control circuit, configured to: transmit the calendar invite with the phone number.

An embodiment of the present invention provides a non-transitory computer readable medium including instructions for an electronic system, including: operating a calendar application; generating a calendar invite with a phone number; and transmitting the calendar invite with the phone number.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

FIG. 1 is an electronic system with calendar mechanism in an embodiment of the present invention.

FIG. 2 is an example of displaying inviting with a phone number.

FIG. 3 is an example of displaying a portion of a calendar invite.

FIG. 4 is an example of displaying a message board.

FIG. 5 is an example of displaying a view of an application calendar.

FIG. 6 is an example of displaying a status and the response from the participants.

FIG. 7 is an exemplary block diagram of the electronic system in an embodiment.

FIG. 8 is an example of a control flow of the electronic system.

FIG. 9 is an example of a control flow of the setup module.

FIG. 10 is an example of a control flow of the invite module.

FIG. 11 is an example of a control flow of the monitor module.

FIG. 12 is an example of a control flow of the update module.

FIG. 13 is an example of a control flow of the event module.

FIG. 14 is a flow chart of a method of operation of an electronic system in an embodiment of the present invention.

### DETAILED DESCRIPTION

In the following description, numerous specific details are set forth to provide a thorough understanding of the presently disclosed technology. In other embodiments, the techniques introduced here can be practiced without these specific details. In other instances, well-known features, such as specific functions or routines, are not described in detail in order to avoid unnecessarily obscuring the present disclosure. References in this description to “an embodiment,” “one embodiment,” or the like mean that a particular feature, structure, material, or characteristic being described is included in at least one embodiment of the present disclosure. The appearances of such phrases in this specification do not necessarily all refer to the same embodiment. On the other hand, such references are not necessarily mutually exclusive. Furthermore, the particular features, structures, materials, or characteristics can be combined in any suitable manner in one or more embodiments.

It is to be understood that the various embodiments shown in the figures are merely illustrative representations. Further, the drawings showing embodiments of the system are semi-diagrammatic, and not to scale and, particularly, some of the dimensions are for the clarity of presentation and are shown exaggerated in the drawing figures. Similarly, although the views in the drawings for ease of description generally show similar orientations, this depiction in the figures is arbitrary for the most part. Generally, the invention can be operated in any orientation.

Several details describing structures or processes that are well-known and often associated with electronic systems and subsystems, but that can unnecessarily obscure some significant aspects of the disclosed techniques, are not set forth in the following description for purposes of clarity. Moreover, although the following disclosure sets forth several embodiments of different aspects of the present technology, several other embodiments can have different configurations or different components than those described in this section. Accordingly, the disclosed techniques can have other embodiments with additional elements or without several of the elements described below.

Many embodiments or aspects of the present disclosure described below can take the form of computer-executable or controller-executable instructions, including routines executed by a programmable computer or controller or electronic devices. Those skilled in the relevant art will appreciate that the disclosed techniques can be practiced on electronic or computer or controller systems other than those shown and described below. The techniques described herein can be embodied in a special-purpose electronic or computer or data processor that is specifically programmed, configured, or constructed to execute one or more of the computer-executable instructions described below. Accordingly, the terms “computer” and “controller” as generally used herein refer to any data processor and can include Internet appliances and handheld devices, including palm-top computers, wearable computers, cellular or mobile phones, multi-processor systems, processor-based or programmable consumer electronics, network computers, mini computers, and the like. Information handled by these electronic systems and computers and controllers can be presented at any suitable display medium, including a liquid crystal display (LCD). Instructions for executing electronic- or computer- or controller-executable tasks can be stored in or on any suitable computer-readable medium, including hardware, firmware, or a combination of hardware and firmware. Instructions can be contained in any suitable memory device, including, for example, a flash drive, USB device, and/or other suitable medium.

The terms “coupled” and “connected,” along with their derivatives, can be used herein to describe structural relationships between components. It should be understood that these terms are not intended as synonyms for each other. Rather, in particular embodiments, “connected” can be used to indicate that two or more elements are in direct contact with each other. Unless otherwise made apparent in the context, the term “coupled” can be used to indicate that two or more elements are in either direct or indirect (with other intervening elements between them) contact with each other, or that the two or more elements cooperate or interact with each other (e.g., as in a cause-and-effect relationship, such as for signal transmission/reception or for function calls), or both.

The following embodiments are described in sufficient detail to enable those skilled in the art to make and use the invention. It is to be understood that other embodiments would be evident based on the present disclosure, and that system, process, or mechanical changes may be made without departing from the scope of an embodiment of the present invention.

The term “module” or “unit” referred to herein can include software, hardware, mechanical mechanisms, or a combination thereof in an embodiment of the present invention, in accordance with the context in which the term is used. For example, the software can be machine code, firmware, embedded code, or application software. Also, for example, the hardware can be circuitry, a processor, a special purpose computer, an integrated circuit, integrated circuit cores, a pressure sensor, an inertial sensor, a microelectromechanical system (MEMS), a passive device, or a combination thereof. Furthermore, the mechanical mechanism can include actuators, motors, arms, joints, handles, end effectors, guides, mirrors, anchoring bases, vacuum lines, vacuum generators, liquid source lines, or stoppers. Further, if a “module” or “unit” is written in the system claims section below, the “module” or “unit” is deemed to include hardware circuitry for the purposes and the scope of the system claims.

The modules or units in the following description of the embodiments can be coupled or attached to one another as described or as shown. The coupling or attachment can be direct or indirect without or with intervening items between coupled or attached modules or units. The coupling or attachment can be by physical contact or by communication between modules or units.

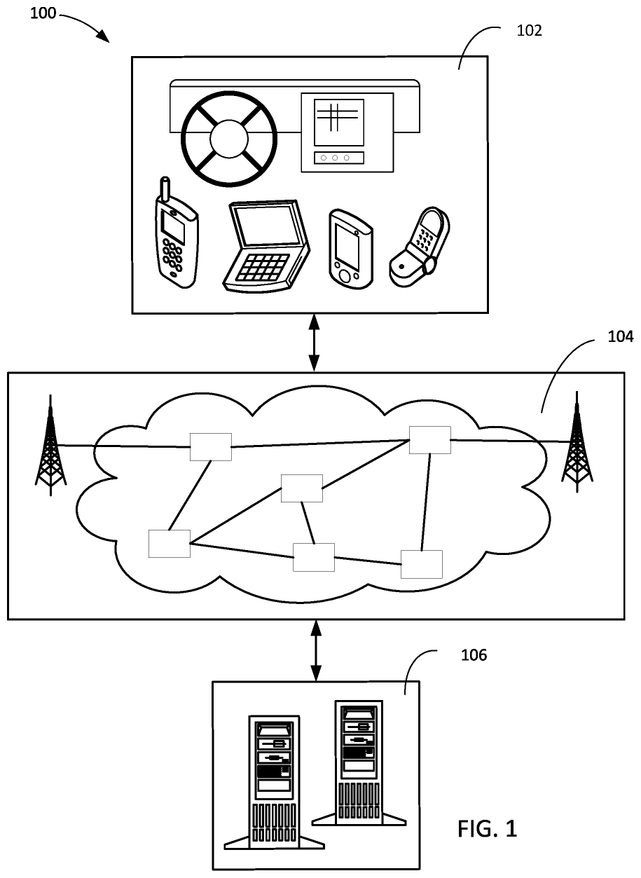

Referring now to FIG. 1, therein is shown a electronic system 100 with a start mechanism in an embodiment of the present invention. The electronic system 100 includes a first device 102, such as a client or a server, connected to a second device 106, such as a client or server. The first device 102 can communicate with the second device 106 with a communication path 104, such as a wireless or wired network.

For example, the first device 102 can be of any of a variety of devices, such as a vehicle, a telematics system in a vehicle, a computing device, a cellular phone, a tablet computer, a smart phone, a notebook computer, vehicle embedded navigation system, or computing device. The first device 102 can couple, either directly or indirectly, to the communication path 104 to communicate with the second device 106 or can be a stand-alone device.

The second device 106 can be any of a variety of centralized or decentralized computing devices, sensor devices to take measurements or record environmental information, such as sensor instruments, sensor equipment, or a sensor array. For example, the second device 106 can be a multimedia computer, a laptop computer, a desktop computer, grid-computing resources, a virtualized computer resource, cloud computing resource, routers, switches, peer-to-peer distributed computing devices, or a combination thereof.

The second device 106 can be mounted externally or internally to a vehicle, centralized in a single room or within a vehicle, distributed across different rooms, distributed across different geographical locations, embedded within a telecommunications network. The second device 106 can couple with the communication path 104 to communicate with the first device 102.

For illustrative purposes, the electronic system 100 is described with the second device 106 as a computing device, although it is understood that the second device 106 can be different types of devices, such as a standalone sensor or measurement device. Also for illustrative purposes, the electronic system 100 is shown with the second device 106 and the first device 102 as end points of the communication path 104, although it is understood that the electronic system 100 can have a different partition between the first device 102, the second device 106, and the communication path 104. For example, the first device 102, the second device 106, or a combination thereof can also function as part of the communication path 104.

The communication path 104 can span and represent a variety of networks and network topologies. For example, the communication path 104 can include wireless communication, wired communication, optical, ultrasonic, or the combination thereof. Satellite communication, cellular communication, Bluetooth, Infrared Data Association standard (IrDA), wireless fidelity (WiFi), and worldwide interoperability for microwave access (WiMAX) are examples of wireless communication that can be included in the communication path 104. Ethernet, digital subscriber line (DSL), fiber to the home (FTTH), and plain old telephone service (POTS) are examples of wired communication that can be included in the communication path 104. Further, the communication path 104 can traverse a number of network topologies and distances. For example, the communication path 104 can include direct connection, personal area network (PAN), local area network (LAN), metropolitan area network (MAN), wide area network (WAN), or a combination thereof.

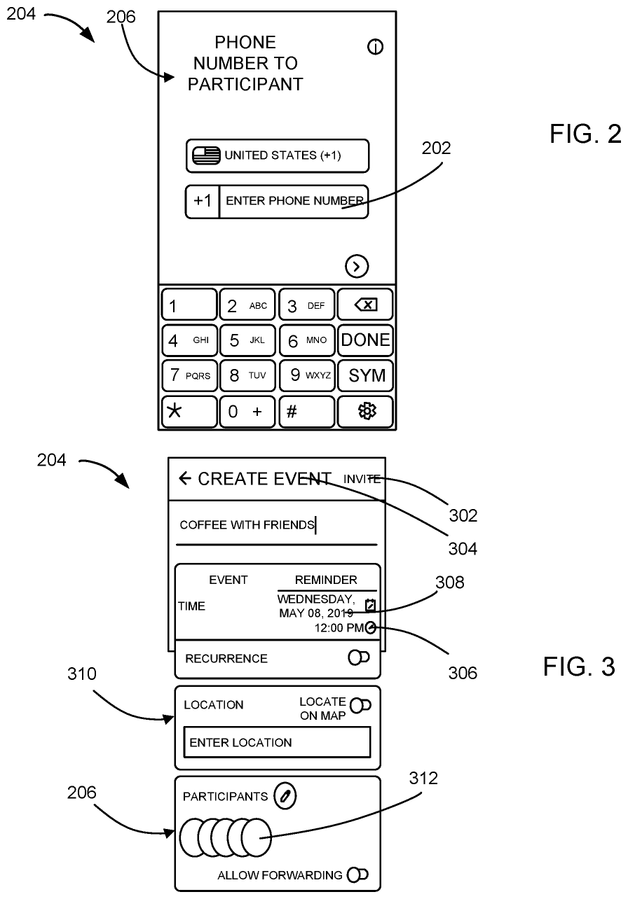

Referring now to FIG. 2, therein is shown an example of a displaying inviting with a phone number 202. A calendar application 204 can invite participants 206 with the phone number 202 for the participants 206. The calendar application 204 does not require any other information to invite the participants 206 other than the phone number 202. The calendar application 204 can utilize the phone number 202 that is new.

The operation, display, or a combination thereof of the calendar application 204 can be by the first device 102 of FIG. 1, the second device 106 of FIG. 1, or a combination thereof. The operation, display, or a combination thereof of the calendar application 204 can be distributed between the first device 102 and the second device 106. The communication of the phone number 202 can be over the communication path 104 of FIG. 1. The use of the phone number 202 by the calendar application 204 to invite the participants 206 will be described later.

Referring now to FIG. 3, therein is shown an example of displaying a portion of a calendar invite 302. FIG. 2 depicts a display for the operation of the calendar application 204 inviting one of the participants 206. FIG. 3 depicts the calendar invite 302 generated by the calendar application 204.

FIG. 3 depicts the calendar invite 302 including a calendar event 304. The calendar invite 302 includes a time 306, a date 308, a location 310, or a combination thereof associated with the calendar event 304. FIG. 3 depicts the participants 206 at the lower portion. FIG. 3 indicates some of the participants 206 can include moderators 312 with some delegation of authority and in the example shown in FIG. 3, the authority to allow forwarding of the calendar invite 302. The calendar invite 302, the calendar event 304, the participants 206, and the moderators 312 will be described later.

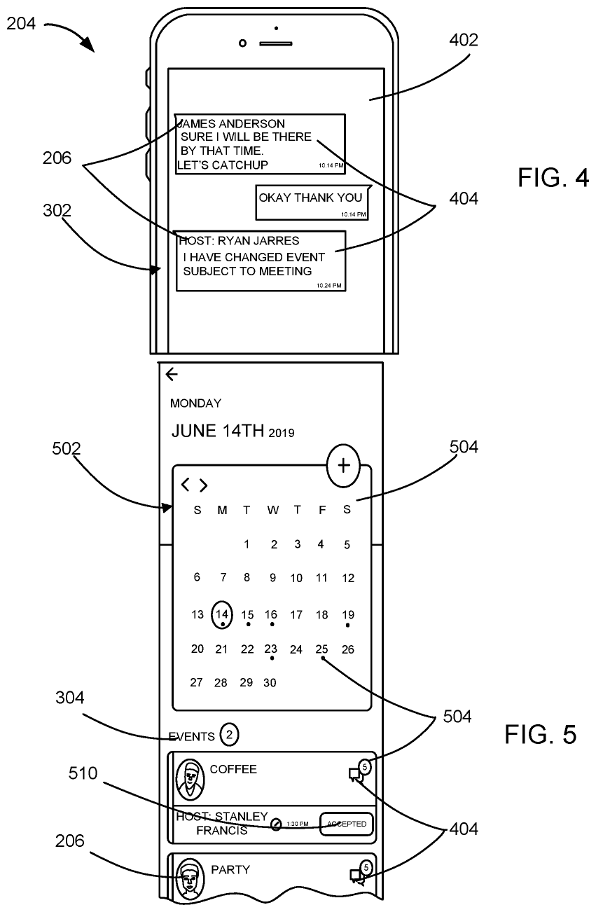

Referring now to FIG. 4, therein is shown an example of displaying a message board 402. As part of the calendar invite 302 of FIG. 3, the calendar invite 302 can also include the message board 402. The message board 402 allows communication between the participants 206. The calendar application 204 can also communicate with the participants 206 about the calendar invite 302 of FIG. 2, the calendar event 304 of FIG. 2, or a combination thereof over the message board 402. The calendar application 204 can also retrieve information from the message board 402 as well. FIG. 4 depicts a message 404 between the participants *. The message board 402 will be described later.

Referring now to FIG. 5, therein is shown an example of displaying a view 502 of an application calendar 504. FIG. 5 depicts the view 502 as a monthly view in the application calendar 504. The dot below the date within the month can depict the message 404 for that date. Below the view 502 of the monthly calendar, a number of the calendar event 304 as shown along with an unread number 508 of the message 404 for that particular instance of the message board 402 associated to the calendar event 304. One of the calendar event 304 depicted in FIG. 5 also depicts a response 510 by one of the participants 206 as accepted. The view 502, the unread number 508, and the response 510 will be described later.

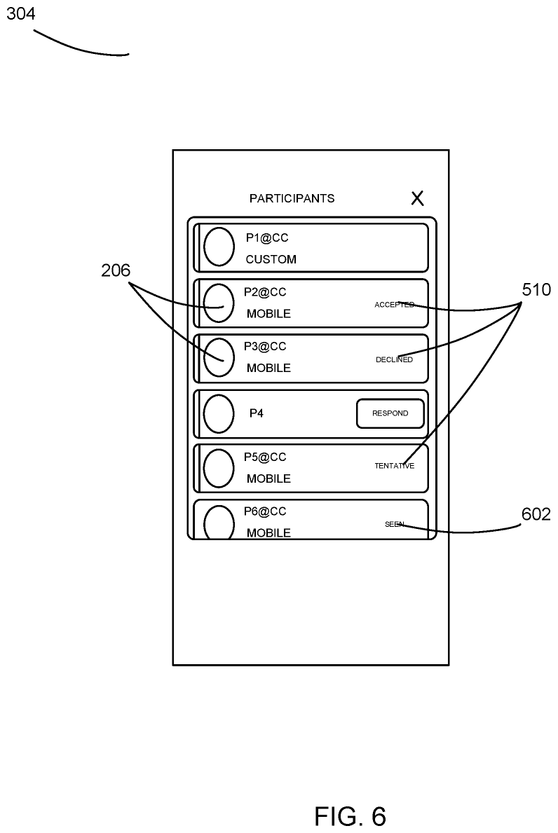

Referring now to FIG. 6, therein is shown an example of displaying a status 602 and the response 510 from the participants 206. FIG. 6 depicts the status 602 of the calendar invite 302 of FIG. 3, the calendar event 304 of FIG. 3, or a combination thereof based on the response 510 from the participants 206. FIG. 6 shows a list of the participants 206 for the calendar invite 302 or the calendar event 304. The display shows the response 510 for each of the participants 206 as “ACCEPTED”, “DECLINED”, and “TENTATIVE” as well as the status 602 as “SEEN”. The status 602 and the response 510 will be described later.

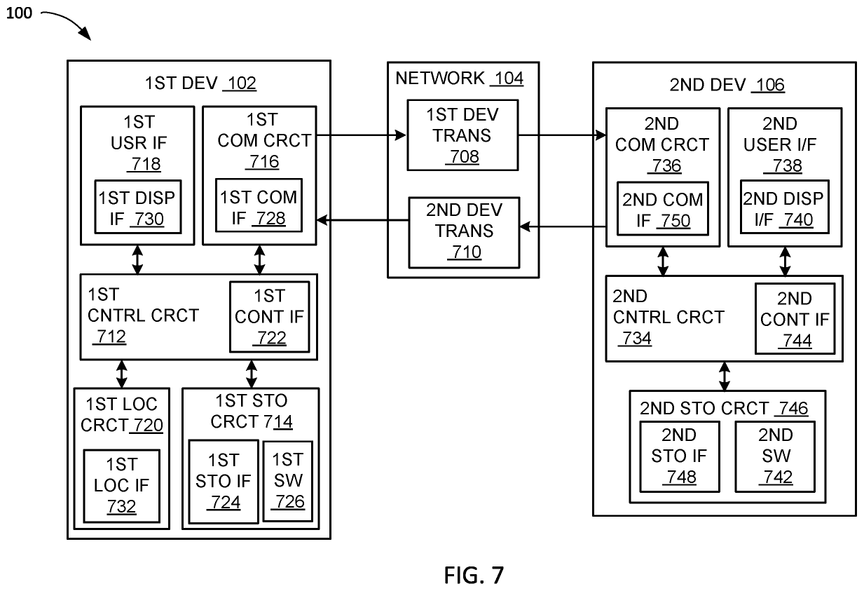

Referring now to FIG. 7, therein is shown an exemplary block diagram of the electronic system 100. The electronic system 100 can include the first device 102, the communication path 104, and the second device 106 o. The first device 102 can send information in a first device transmission 708 over the communication path 104 to the second device 106. The second device 106 can send information in a second device transmission 710 of FIG. 7 over the communication path 104 to the first device 102.

For illustrative purposes, the electronic system 100 is shown with the first device 102 as a client device, although it is understood that the electronic system 100 can include the first device 102 as a different type of device. For example, the first device 102 can be a server including a display interface.

Also for illustrative purposes, the electronic system 100 is shown with the second device 106 as a server, although it is understood that the electronic system 100 can include the second device 106 as a different type of device. For example, the second device 106 can be a client device.

Further for illustrative purposes, the electronic system 100 is shown with interaction between the first device 102 and the second device 106, although it is understood that the first device 102 can similarly interact another instance of the first device 102. Similarly, the second device 106 can similarly interact with another instance of the second device 106.

For brevity of description in this embodiment of the present invention, the first device 102 will be described as a client device and the second device 106 will be described as a server device. The embodiment of the present invention is not limited to this selection for the type of devices. The selection is an example of an embodiment of the present invention.

The first device 102 can include a first control circuit 712, a first storage circuit 714, a first communication circuit 716, and a first user interface 718, and a first location circuit 720. The first control circuit 712 can include a first control interface 722. The first control circuit 712 can execute a first software 726 o to provide the intelligence of the electronic system 100.

The first control circuit 712 can be implemented in a number of different manners. For example, the first control circuit 712 can be a processor, an application specific integrated circuit (ASIC) an embedded processor, a microprocessor, a hardware control logic, a hardware finite state machine (FSM), a digital signal processor (DSP), or a combination thereof. The first control interface 722 can be used for communication between the first control circuit 712 and other functional units or circuits in the first device 102. The first control interface 722 can also be used for communication that is external to the first device 102.

The first control interface 722 can receive information from the other functional units/circuits or from external sources, or can transmit information to the other functional units/circuits or to external destinations. The external sources and the external destinations refer to sources and destinations external to the first device 102.

The first control interface 722 can be implemented in different ways and can include different implementations depending on which functional units/circuits or external units/circuits are being interfaced with the first control interface 722. For example, the first control interface 722 can be implemented with a pressure sensor, an inertial sensor, a microelectromechanical system (MEMS), optical circuitry, waveguides, wireless circuitry, wireline circuitry, or a combination thereof.

The first storage circuit 714 can store the first software 726. The first storage circuit 714 can also store the relevant information, such as data representing incoming images, data representing previously presented image, sound files, or a combination thereof.

The first storage circuit 714 can be a volatile memory, a nonvolatile memory, an internal memory, an external memory, or a combination thereof. For example, the first storage circuit 714 can be a nonvolatile storage such as non-volatile random access memory (NVRAM), Flash memory, disk storage, or a volatile storage such as static random access memory (SRAM).

The first storage circuit 714 can include a first storage interface 724. The first storage interface 724 can be used for communication between the first storage circuit 714 and other functional units or circuits in the first device 102. The first storage interface 724 can also be used for communication that is external to the first device 102.

The first storage interface 724 can receive information from the other functional units/circuits or from external sources, or can transmit information to the other functional units/circuits or to external destinations. The external sources and the external destinations refer to sources and destinations external to the first device 102.

The first storage interface 724 can include different implementations depending on which functional units/circuits or external units/circuits are being interfaced with the first storage circuit 714. The first storage interface 724 can be implemented with technologies and techniques similar to the implementation of the first control interface 722.

The first communication circuit 716 can enable external communication to and from the first device 102. For example, the first communication circuit 716 can permit the first device 102 to communicate with the second device 106 of FIG. 1, an attachment, such as a peripheral device or a desktop computer, and the communication path 104.

The first communication circuit 716 can also function as a communication hub allowing the first device 102 to function as part of the communication path 104 and not limited to be an end point or terminal circuit to the communication path 104. The first communication circuit 716 can include active and passive components, such as microelectronics or an antenna, for interaction with the communication path 104.

The first communication circuit 716 can include a first communication interface 728. The first communication interface 728 can be used for communication between the first communication circuit 716 and other functional units or circuits in the first device 102. The first communication interface 728 can receive information from the other functional units/circuits or can transmit information to the other functional units or circuits.

The first communication interface 728 can include different implementations depending on which functional units or circuits are being interfaced with the first communication circuit 716. The first communication interface 728 can be implemented with technologies and techniques similar to the implementation of the first control interface 722.

The first user interface 718 allows a user (not shown) to interface and interact with the first device 102. The first user interface 718 can include an input device and an output device. Examples of the input device of the first user interface 718 can include a keypad, a touchpad, soft-keys, a keyboard, a microphone, an infrared sensor for receiving remote signals, or any combination thereof to provide data and communication inputs.

The first user interface 718 can include a first display interface 730. The first display interface 730 can include an output device. The first display interface 730 can include a display, a projector, a video screen, a speaker, or any combination thereof.

The first control circuit 712 can operate the first user interface 718 to display information generated by the electronic system 100. The first control circuit 712 can also execute the first software 726 for the other functions of the electronic system 100, including receiving location information from the first location circuit 720. The first control circuit 712 can further execute the first software 726 for interaction with the communication path 104 via the first communication circuit 716.

The first location circuit 720 can generate location information, current heading, current acceleration, and current speed of the first device 102, as examples. The first location circuit 720 can be implemented in many ways. For example, the first location circuit 720 can function as at least a part of the global positioning system, an inertial electronic system, a cellular-tower location system, a pressure location system, or any combination thereof. Also, for example, the first location circuit 720 can utilize components such as an accelerometer or global positioning system (GPS) receiver.

The first location circuit 720 can include a first location interface 732. The first location interface 732 can be used for communication between the first location circuit 720 and other functional units or circuits in the first device 102. The first location interface 732 can also be used for communication external to the first device 102.

The first location interface 732 can receive information from the other functional units/circuits or from external sources, or can transmit information to the other functional units/circuits or to external destinations. The external sources and the external destinations refer to sources and destinations external to the first device 102.

The first location interface 732 can include different implementations depending on which functional units/circuits or external units/circuits are being interfaced with the first location circuit 720. The first location interface 732 can be implemented with technologies and techniques similar to the implementation of the first control circuit 712.

The second device 106 can be optimized for implementing an embodiment of the present invention in a multiple device embodiment with the first device 102. The second device 106 can provide the additional or higher performance processing power compared to the first device 102. The second device 106 can include a second control circuit 734, a second communication circuit 736, a second user interface 738, and a second storage circuit 746.

The second user interface 738 allows a user (not shown) to interface and interact with the second device 106. The second user interface 738 can include an input device and an output device. Examples of the input device of the second user interface 738 can include a keypad, a touchpad, soft-keys, a keyboard, a microphone, or any combination thereof to provide data and communication inputs. Examples of the output device of the second user interface 738 can include a second display interface 740 of FIG. 7. The second display interface 740 can include a display, a projector, a video screen, a speaker, or any combination thereof.

The second control circuit 734 can execute a second software 742 of FIG. 7 to provide the intelligence of the second device 106 of the electronic system 100. The second software 742 can operate in conjunction with the first software 726. The second control circuit 734 can provide additional performance compared to the first control circuit 712.

The second control circuit 734 can operate the second user interface 738 to display information. The second control circuit 734 can also execute the second software 742 for the other functions of the electronic system 100, including operating the second communication circuit 736 to communicate with the first device 102 over the communication path 104.

The second control circuit 734 can be implemented in a number of different manners. For example, the second control circuit 734 can be a processor, an embedded processor, a microprocessor, hardware control logic, a hardware finite state machine (FSM), a digital signal processor (DSP), or a combination thereof.

The second control circuit 734 can include a second control interface 744 of FIG. 7. The second control interface 744 can be used for communication between the second control circuit 734 and other functional units or circuits in the second device 106. The second control interface 744 can also be used for communication that is external to the second device 106.

The second control interface 744 can receive information from the other functional units/circuits or from external sources, or can transmit information to the other functional units/circuits or to external destinations. The external sources and the external destinations refer to sources and destinations external to the second device 106.

The second control interface 744 can be implemented in different ways and can include different implementations depending on which functional units/circuits or external units/circuits are being interfaced with the second control interface 744. For example, the second control interface 744 can be implemented with a pressure sensor, an inertial sensor, a microelectromechanical system (MEMS), optical circuitry, waveguides, wireless circuitry, wireline circuitry, or a combination thereof.

The second storage circuit 746 can store the second software 742. The second storage circuit 746 can also store the information such as data representing incoming images, data representing previously presented image, sound files, or a combination thereof. The second storage circuit 746 can be sized to provide the additional storage capacity to supplement the first storage circuit 714.

For illustrative purposes, the second storage circuit 746 is shown as a single element, although it is understood that the second storage circuit 746 can be a distribution of storage elements. Also for illustrative purposes, the electronic system 100 is shown with the second storage circuit 746 as a single hierarchy storage system, although it is understood that the electronic system 100 can include the second storage circuit 746 in a different configuration. For example, the second storage circuit 746 can be formed with different storage technologies forming a memory hierarchal system including different levels of caching, main memory, rotating media, or off-line storage.

The second storage circuit 746 can be a volatile memory, a nonvolatile memory, an internal memory, an external memory, or a combination thereof. For example, the second storage circuit 746 can be a nonvolatile storage such as non-volatile random access memory (NVRAM), Flash memory, disk storage, or a volatile storage such as static random access memory (SRAM).

The second storage circuit 746 can include a second storage interface 748. The second storage interface 748 can be used for communication between the second storage circuit 746 and other functional units or circuits in the second device 106. The second storage interface 748 can also be used for communication that is external to the second device 106.

The second storage interface 748 can receive information from the other functional units/circuits or from external sources, or can transmit information to the other functional units/circuits or to external destinations. The external sources and the external destinations refer to sources and destinations external to the second device 106.

The second storage interface 748 can include different implementations depending on which functional units/circuits or external units/circuits are being interfaced with the second storage circuit 746. The second storage interface 748 can be implemented with technologies and techniques similar to the implementation of the second control interface 744.

The second communication circuit 736 can enable external communication to and from the second device 106. For example, the second communication circuit 736 can permit the second device 106 to communicate with the first device 102 over the communication path 104.

The second communication circuit 736 can also function as a communication hub allowing the second device 106 to function as part of the communication path 104 and not limited to be an end point or terminal unit or circuit to the communication path 104. The second communication circuit 736 can include active and passive components, such as microelectronics or an antenna, for interaction with the communication path 104.

The second communication circuit 736 can include a second communication interface 750. The second communication interface 750 can be used for communication between the second communication circuit 736 and other functional units or circuits in the second device 106. The second communication interface 750 can receive information from the other functional units/circuits or can transmit information to the other functional units or circuits.

The second communication interface 750 can include different implementations depending on which functional units or circuits are being interfaced with the second communication circuit 736. The second communication interface 750 can be implemented with technologies and techniques similar to the implementation of the second control interface 744.

The first communication circuit 716 can couple with the communication path 104 to send information to the second device 106 in the first device transmission 708. The second device 106 can receive information in the second communication circuit 736 from the first device transmission 708 of the communication path 104.

The second communication circuit 736 can couple with the communication path 104 to send information to the first device 102 in the second device transmission 710. The first device 102 can receive information in the first communication circuit 716 from the second device transmission 710 of the communication path 104. The electronic system 100 can be executed by the first control circuit 712, the second control circuit 734, or a combination thereof. For illustrative purposes, the second device 106 is shown with the partition containing the second user interface 738, the second storage circuit 746, the second control circuit 734, and the second communication circuit 736, although it is understood that the second device 106 can include a different partition. For example, the second software 742 can be partitioned differently such that some or all of its function can be in the second control circuit 734 and the second communication circuit 736. Also, the second device 106 can include other functional units or circuits not shown in FIG. 7 for clarity.

The functional units or circuits in the first device 102 can work individually and independently of the other functional units or circuits. The first device 102 can work individually and independently from the second device 106 and the communication path 104.

The functional units or circuits in the second device 106 can work individually and independently of the other functional units or circuits. The second device 106 can work individually and independently from the first device 102 and the communication path 104.

The functional units or circuits described above can be implemented in hardware. For example, one or more of the functional units or circuits can be implemented using the a gate, circuitry, a processor, a computer, integrated circuit, integrated circuit cores, a pressure sensor, an inertial sensor, a microelectromechanical system (MEMS), a passive device, a physical non-transitory memory medium containing instructions for performing the software function, a portion therein, or a combination thereof.

For illustrative purposes, the electronic system 100 is described by operation of the first device 102 and the second device 106. It is understood that the first device 102 and the second device 106 can operate any of the modules and functions of the electronic system 100.

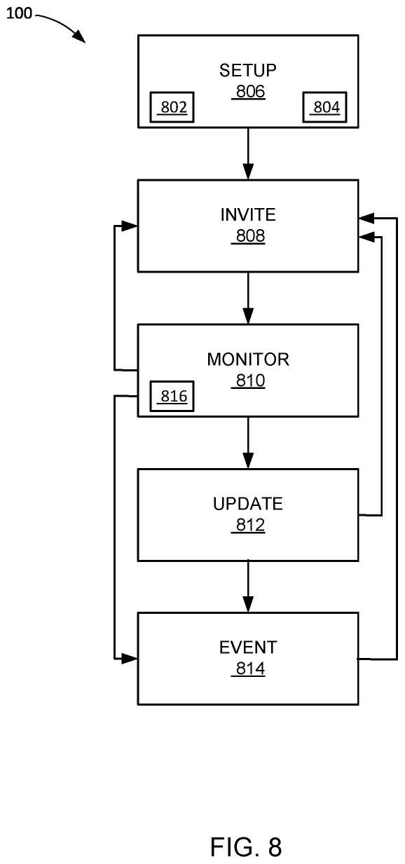

Referring now to FIG. 8, therein is shown a control flow of the electronic system 100 in an embodiment. The electronic system 100 provides, operates, or a combination thereof the calendar application 204 of FIG. 2. The calendar application 204 is a tool for providing scheduling of events, activities, reminders, items, or a combination thereof based on time, date, location, geography, or a combination thereof. The calendar application 204 can involve potentially one or more of the participants 206 of FIG. 2 for the scheduling and other functions. The calendar application 204 can also provide a consolidation 802 of electronic calendars 804. The calendar application 204 can provide the view 502 of FIG. 5 of the application calendar 504 of FIG. 5.

As an example, the electronic system 100 can include a setup module 806, an invite module 808, a monitor module 810, an update module 812, and an event module 814. As described earlier, the electronic system 100 can include the first device 102 of FIG. 1, the communication path 104 of FIG. 1, and the second device 106 of FIG. 1. The first device 102 can send information over the communication path 104 to the second device 106. The second device 106 can send information over the communication path 104 to the first device 102. However, the first device 102 and the second device 106 can be discussed interchangeably.

The control flow can be implemented by the first software 726 of FIG. 7, the second software 742 of FIG. 7, or a combination thereof. The first software 726 and the second software 742 separately, jointly, or individually can be executed by the first control circuit 712 of FIG. 7, the second control circuit 734 of FIG. 7, or a combination thereof.

The first software 726 can be stored in the first storage circuit 714 of FIG. 7 or the second storage circuit 746 of FIG. 7 or distributed between the two. The second software 742 can be stored in the first storage circuit 714 or the second storage circuit 746 or distributed between the two. The control flow can transit commands or to invoke actions utilizing the first communication circuit 716 of FIG. 7, the first communication interface 728 of FIG. 7, the first control interface 722 of FIG. 7, the first storage interface 724 of FIG. 7, or a combination thereof as needed. The control flow can transit commands or to invoke actions utilizing the second communication circuit 736 of FIG. 7, the second communication interface 750 of FIG. 7, the second control interface 744 of FIG. 7, the second storage interface 748 of FIG. 7, or a combination thereof as needed.

The modules described in this application can be stored in the non-transitory computer readable medium. The first storage circuit 714 of FIG. 7, the second storage circuit 746 of FIG. 7, or a combination thereof can represent the non-transitory computer readable medium. The first storage circuit 714, the second storage circuit 746, or a combination thereof, or a portion therein can be removable from the first device 102, the second device 106, or a combination thereof. Examples of the non-transitory computer readable medium can be a non-volatile memory card or stick, an external hard disk drive, a tape cassette, or an optical disk.

The setup module 806, the invite module 808, the monitor module 810, the update module 812, and the event module 814 can be coupled using wired or wireless connections, by including an output of one module as an input of the other, by including operations of one module influence operation of the other module, or a combination thereof. The portions of the control flow can be directly coupled with no intervening structures or objects other than the connector there-between, or indirectly coupled.

The setup module 806 provides the initial loading, installation, or a combination thereof of the calendar application 204 for operation. The electronic system 100 can flow from the setup module 806 to the invite module 808.

The invite module 808 can generate the calendar invite 302 of FIG. 3 from the calendar application 204. The electronic system 100 can flow from the invite module 808 to the monitor module 810. The calendar invite 302 represent a request to join the calendar event 304 of FIG. 3. The calendar invite 302 can include information related to the calendar event 304. As examples, the calendar invite 302 can include one or more of the participants 206, the date 308 of FIG. 3, the time 306 of FIG. 3, the location 310 of FIG. 3 as a geographical location, a meeting location that can be a virtual location, purpose, associated events, or a combination thereof and information or updates thereof.

The monitor module 810 can track the calendar invite 302 generated or received by the calendar application 204. In the example shown in FIG. 8, the electronic system 100 can flow from the monitor module 810 to the update module 812 based on the status 602 of FIG. 6 of the calendar invite 302 being tracked. Also shown in this example, the electronic system 100 can flow from the monitor module 810 looping back to the invite module 808 when the monitor module 810 detects a new participant 816 associated with the calendar invite 302. Also shown in this example, the electronic system 100 can flow from the monitor module 810 to the event module 814 when a modification to the calendar invite 302 is not necessary.

The status 602 of FIG. 6 includes information relating to the calendar invite 302. The status 602 can include items included in the calendar invite 302 or updates thereto.

The update module 812 can determine when a refresh is required for any of the calendar invite 302 associated with the calendar application 204. A refresh can be required when one or more items in the calendar invite 302 is modified or can be modified. Similar to the monitor module 810, the electronic system 100 can also flow from the update module 812 to multiple paths. As an example, the electronic system 100 can flow from the update module 812 to the event module 814 based on the status 602 of the calendar invite 302 being tracked. Also as an example, the electronic system 100 can flow from the update module 812 looping back to the invite module 808 based on the new participant 816 associated with the calendar invite 302.

The event module 814 can determine if the calendar invite 302 has expired or occurred based on the items included in the calendar invite 302 including the time 306, the date 308, availability of the location 310, or a combination thereof. In the example shown in FIG. 8, the electronic system 100 can flow from the event module 814 to the invite module 808 to generate or modify or generate a follow-up to the calendar invite 302 for a future date, a future time, a different location, a different geography, or a combination thereof.

For illustrative purposes, the electronic system 100 is shown with sequential flow with some loops, although it is understood that the electronic system 100 can operate differently. For example, some of the modules shown in FIG. 8 can be optional. As a specific example, the setup module 806 can be optional if the calendar application 204 is already resident and operating on the first device 102, the second device 106, or a combination thereof where being utilized. Also as a specific example, the loop back from the monitor module 810 to the invite module 808 can be optional if what is tracked with the calendar invite 302 does not require the new participant 816 or the participants 206 does not require the calendar invite 302 to be resent based on updated and detected information by the calendar application 204. Further as a specific example, the update module 812 can be optional if a refresh is not required for the calendar invite 302 associated with the calendar application 204. Yet further as a specific example, the loop back from the event module 814 to the invite module 808 can be optional if the calendar invite 302 is not required for a future date and time.

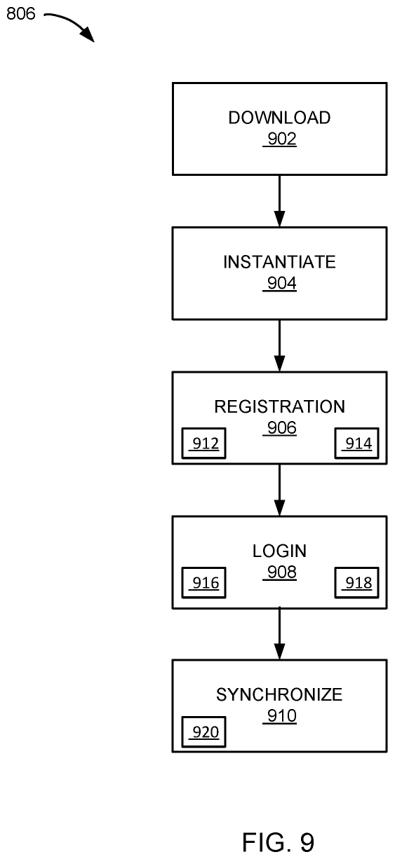

Referring now to FIG. 9, therein is shown the control flow for the setup module 806 in an embodiment. The setup module 806 performs the initial loading, installation, or a combination thereof of the calendar application 204 of FIG. 2 for operation.

As an example, the setup module 806 can include a download module 902, an instantiate module 904, a registration module 906, a login module 908, and a synchronize module 910. The download module 902 performs the initial loading of the calendar application 204. The instantiate module 904 performs the installation of the calendar application 204. The registration module 906 generates of an account 912 for operating in the calendar application 204. The synchronize module 910 gathers of information stored on the first device 102 of FIG. 1, the second device 106 of FIG. 1, or a combination thereof with the calendar application 204.

Returning to the description of the download module 902, the download module 902 can load the calendar application 204 as a preload. The preload represents receiving information for the calendar application 204 without installation. The download module 902 or a portion of the function can be optional if the calendar application 204 is already loaded or installed on the electronic system 100 or as a more specific example on the first device 102, the second device 106, or a combination thereof. The information received as a preload or load with install can be used to install the calendar application 204.

The download module 902 can preload or load the information for the calendar application 204 to the first device 102, the second device 106, or a combination thereof depending on which of the device in the electronic system 100 invoked the action. The flow can progress from the download module 902 to the instantiate module 904.

Returning to the description of the instantiate module 904, the instantiate module 904 can perform the installation of the calendar application 204. The instantiate module 904 can perform the installation in a number of ways. For example, the installation can be on one device in the electronic system 100, such as the first device 102 or the second device 106, allowing for operation of the calendar application 204 on the single device where the installation is completed. As a further example, the installation can be over multiple devices in the electronic system 100, such as across both the first device 102 and the second device 106, allowing for operation of the calendar application 204 distributed between the first device 102 and the second device 106.

For illustrative purposes, the electronic system 100 is described as the installation on one device or across multiple devices of different types, although it is understood that the electronic system 100 can operate differently. For example, the instantiate module 904 can perform multiple and unique installation for a number of the first device 102, the second device 106, or a combination thereof. As another example, the instantiate module 904 can perform a single installation across multiple instances of the first device 102, multiple instances of the second device 106, or a combination thereof.

The invocation or operation of the calendar application 204 can be displayed within the electronic system 100 or as a more specific example on the first device 102, the second device 106, or a combination thereof depending on the device where the invocation occurred.

Once installed, the calendar application 204 can be invoked allowing the setup module 806 to continue the preparation for operation. The flow can progress from the instantiate module 904 to the registration module 906.

Returning to the description of the registration module 906, the registration module 906 can generate the account 912 to be associated with the calendar application 204. The account 912 is information associated with a specific user or group of users of the calendar application 204. When the account 912 does not exist on the device that invoked the calendar application 204, then the calendar application 204, the registration module 906 or a combination thereof can generate the account 912 as appropriate. Also, the calendar application 204, the registration module 906, or a combination thereof can generate a further instance of the account 912 if one does not exists associated with a specific user or a group of users.

Continuing with the registration module 906, the registration module 906 can utilize the phone number 202 of FIG. 2 as a part of generating the account 912. The phone number 202 is an identification string or numbers associated with a communication device. In this example, the phone number 202 is accessible by the person executing the registration module 906, the calendar application 204 or a combination thereof. As an example, the phone number 202 can include a country code, an identification sequence specific for that country or region to uniquely identify a communication device. As a specific example, the phone number 202 for the communication device, such as a smart phone, cellular phone, a tablet, or a combination thereof, in the United States can also include an area code and a line number.

The registration module 906 can utilize the phone number 202 to generate the account 912 in a number of ways. For example, the registration module 906 can generate a verification code to validate the phone number 202 that is appropriately associated with the account 912 being created or generated. The account 912 can utilize the verification code such as a one-time passcode transmitted to the communication device uniquely identified by and associated with the phone number 202.

The account 912 can be secured by the creation or generation of a personal identification number or a password for the account 912 for the calendar application 204. The personal identification number is a series of numbers, characters, biometric information, or a combination thereof that permits access to the account 912. The password is a series of alphabetic characters, biometric information, images, or other uniquely identifying information that permit access to the account 912.

The account 912 can be generated without being associated with an electronic mail address 914 or the electronic mail address 914 is optional. The electronic mail address 914 provides a unique identification for a specific user or group of users following the format of a local part or username of a recipient immediately followed by the symbol “A” immediately followed by a domain name. The electronic mail address 914 is not the phone number 202.

Once the account 912 is generated, the calendar application 204 can be invoked allowing the setup module 806 to continue the preparation for operation. The flow can progress from the registration module 906 to the login module 908.

Returning to the description of the login module 908, the login module 908 can detect or validate the account 912 to operate the calendar application 204. The login module 908 can display options for the account 912 if more than one exists for the calendar application 204. The login module 908 allows access to the appropriate instance of the account 912 with the appropriate credentials for the specific instance of the account 912. For example, the password can be the appropriate credentials.

The login module 908 can allow the account 912 to be modified. For example, the account 912 can be modified to be associated with a new phone number 916, a secondary phone number 918, or a combination thereof.

The new phone number 916 has the same description of the phone number 202. The new phone number 916 can be an updated identification for the person or group previously associated with the phone number 202. The new phone number 916 can be a replacement for the phone number 202 associated with the account 912.

The secondary phone number 918 has the same description of the phone number 202. The secondary phone number 918 can be an updated identification for the person or group previously associated with the phone number 202. The secondary phone number 918 can be an alternative identification for the person or group associated with the phone number 202. The secondary phone number 918 does not necessarily replace the phone number 202.

For illustrative purposes, the calendar application 204 is described as updating the phone number 202 with the new phone number 916, the secondary phone number 918, or a combination thereof, although it is understood that the calendar application 204, the login module 908, or a combination thereof can modify the account 912 differently. For example, the account 912 can be modified with a group list of more than one of the phone number 202 for different or the same user. The group list includes more than one of the phone number 202 whether the phone number 202 is new or different than the original identification of the phone number 202. Also for example, the account 912 can be modified with a sequential order of the phone number 202 when additional numbers are added, such as the secondary phone number 918 is utilized after the phone number 202 or the new phone number 916 has failed to access the calendar application 204.

Once the electronic system 100 successfully allows access and logs into the account 912 of the calendar application 204, the flow can progress from the login module 908 to the synchronize module 910.

Returning to the description of the synchronize module 910, the synchronize module 910 can operate upon the information stored on the first device 102, the second device 106, or a combination thereof with the calendar application 204.

The calendar application 204, the synchronize module 910, or a combination thereof can generate the application calendar 504 of FIG. 5 with the consolidation 802 of FIG. 8 of the electronic calendars 804 of FIG. 8. For example, the consolidation 802 can be of the electronic calendars 804 stored on the first device 102, the second device 106, or a combination thereof. The electronic calendars 804 are scheduling tools operated, stored, and invoked in electronic form or with a computer program. The application calendar 504 represents the combined information of the various instances of the electronic calendars 804.

The application calendar 504 can provide various types of the view 502 of FIG. 5 of the application calendar 504 of FIG. 5 within the calendar application 204. For example, the view 502 can be represented in different manners. As a specific example, the view 502 can represent a daily view, a weekly view, a monthly view, a yearly view, or a view that is a combination of these views or a multiple of each of the views listed. The application calendar 504 can depict the calendar event 304 of FIG. 3 associated with the calendar invite 302 of FIG. 3 in some form of chronological or relational manner.

The calendar application 204 can provide the consolidation 802 of a contact list 920. As an example, the consolidation 802 can be of the contact list 920 stored on the first device 102, the second device 106, or a combination thereof. The consolidation 802 is the aggregation of one or more items relating to a common set. In this example, the common set is the contact list 920 and the consolidation 802 can include items in the contact list 920.

The contact list 920 is information about individuals, groups, entities, or a combination thereof and how to access thereto. Examples of information in the contact list 920 can include the phone number 202, physical address, the electronic mail address 914, a link for a Uniform Resource Locator (URL), a social networking information, or a combination thereof.

For illustrative purposes, the setup module 806 is shown with sequential flow, although it is understood that the setup module 806 can operate differently. For example, some of the modules shown in FIG. 9 can be optional. As a specific example, the download module 902 can be optional if the calendar application 204 is already installed in the electronic system 100. Also as a specific example, the loop back from the synchronize module 910 can be optional if the calendar application 204 already synchronized for the account 912 in the case of a change in the phone number 202. Also as a specific example, the registration module 906 can be optional if a specific user or group of users already have the account 912 for the calendar application 204.

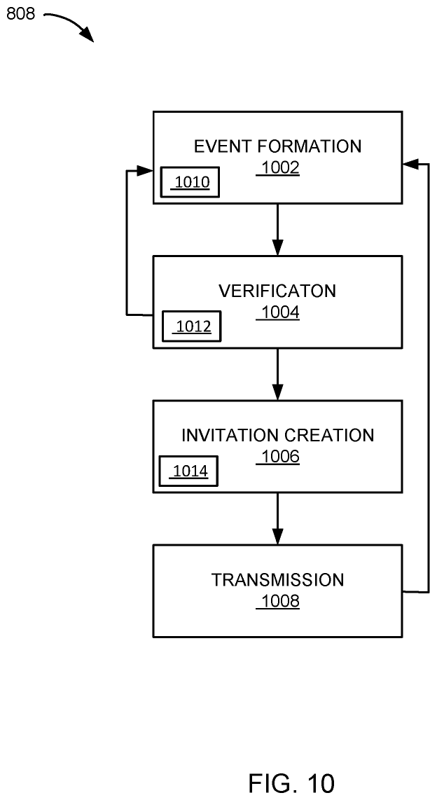

Referring now to FIG. 10, therein is shown the control flow for the invite module 808 in an embodiment. The invite module 808 generates of the calendar invite 302 of FIG. 3 from the calendar application 204 of FIG. 2.

As an example, the invite module 808 can include an event formation module 1002, a verification module 1004, an invitation creation module 1006, and a transmission module 1008. The event formation module 1002 performs the generating of the calendar event 304 of FIG. 3. The verification module 1004 performs the scanning of the electronic calendars 804 of FIG. 8 for availability for the calendar event 304. The invitation creation module 1006 generates of the calendar invite 302. The transmission module 1008 performs the transmitting of the calendar invite 302.

Returning to the description of the event formation module 1002, the event formation module 1002 generates the calendar event 304 in the calendar application 204. The calendar event 304 is the scheduling of events, activities, reminders, items, or a combination thereof.

The calendar application 204 can include the time 306 of FIG. 3, the date 308 of FIG. 3, or a combination thereof to be included in the calendar event 304. The time 306 is the chronological designation within a day. For example, the time 306 can be expressed with the specific hour and minute. As a specific example, the time 306 can be designated in the twelve hour format or twenty four hour format. The date 308 is the chronological designation at a granularity when the time 306 repeats. For example, the date 308 can include designation and granularity for days, weeks, months, or a combination thereof. As another example, the date 308 can represent a specific day of a month in a year. Further for example, the date 308 can be designed with a month, day, year, or a combination thereof.

The calendar event 304 can also include a description, the location 310 of FIG. 3, and a duration. The location 310 can be described in a number of ways. For example, the location 310 can the place or manner for holding the calendar event 304. As a further example, the location 310 can be a specific address, point of interest, particular place, virtual place, URL, or a combination thereof. The duration is a length of time. For example, the duration can be expressed using the granularity of the time 306, the date 308, or a combination thereof. As a specific example, the duration can be described in minutes, hours, days, or a combination thereof.

The calendar event 304 can also include information for the participants 206 of FIG. 3. The participants 206 are persons that are associated with the calendar event 304. The participants 206 can be designated in a number of ways. For example, the phone number 202 of FIG. 2 can be directly entered in the calendar application 204 without being within the contact list 920 of FIG. 9. As a specific example, the participants 206 can be invited without the use or the need of the electronic mail address 914 of FIG. 9 for the participants 206. Also for example, the phone number 202 can be selected in the consolidation of the contact list 920 in the calendar application 204.

The calendar event 304 can also designate key items 1010. The key items 1010 are resources, attributes, or a combination thereof associated with the calendar invite 302 required for the calendar event 304 to proceed or held. For example, the key items 1010 can include the date 308, the time 306, the location 310 for the calendar event 304 to be held. Also for example, the key items 1010 can also include selected identification of the participants 206 or a selected number of the participants 206 required for the calendar event 304 to proceed. Once the calendar event 304 is generated, the flow can progress from the event formation module 1002 to the verification module 1004.

Returning to the description of the verification module 1004, the verification module 1004 can scans the application calendar 504 of FIG. 5 of the calendar application 204 for a conflict 1012. The conflict 1012 is the scheduling of the calendar event 304 where portions of the calendar invite 302 is not available. For example, the calendar application 204, the verification module 1004, or a combination thereof can determine that the conflict 1012 exists when at least one of the key items 1010 for the calendar invite 302 is not available. Also as an example, the conflict 1012 can exist even when the key items 1010 are available but attributes such as the time 306, the date 308, or a combination thereof is not available.

The verification module 1004 can scan the application calendar 504 in a number of ways. For example, the verification module 1004 can scan the application calendar 504 in the first device 102 of FIG. 1, the second device 106 of FIG. 1, or a combination thereof based on the time 306 and the date 308 for the calendar event 304. As a further example, the verification module 1004 can scan the application calendar 504 for recurring instances of the calendar event 304 in the first device 102, the second device 106, or a combination thereof. The recurring instances of the calendar event 304 are the calendar event 304 repeated in a specific interval. For example, recurrence can repeat daily, weekly, monthly, yearly, or a combination thereof.

The calendar application 204, the verification module 1004, or a combination thereof can determine whether the conflict 1012 exists for some or all the recurrence of the calendar event 304. The calendar application 204, the verification module 1004, or a combination thereof can display the conflict 1012 in the calendar application 204. When the conflict 1012 exists, the flow can flow to the event formation module 1002 to provide an opportunity to resolve the conflict 1012. Absent the conflict 1012, the flow can progress to the invitation creation module 1006.

Returning to the description of the invitation creation module 1006, the invitation creation module 1006 generates the calendar invite 302 for the calendar application 204. The calendar invite 302 can include the information of the calendar event 304 with the message board 402 of FIG. 4. The message board 402 is communication medium for the participants 206 designated for the calendar event 304. The calendar application 204 can also communicate with the participants 206 with the message board 402 as well. The message board 402 displays the message 404 of FIG. 4 from and for the participants 206 associated with the calendar invite 302.

The message 404 can represent communication between the participants 206, relating to the calendar invite 302, relating to the calendar event 304, or a combination thereof. The message 404 can include communication with the calendar application 204 and the participants 206. The message board 402 can display the message 404 in a number of ways. For example, the message 404 can be displayed as characters, images, gifs, audio, video, or a combination thereof. Also for example, the message 404 can include replies to the calendar invite 302 or an update 1014 to the calendar invite 302.

The calendar invite 302 can also request the response 510 of FIG. 5 from the participants 206. The response 510 can include an acceptance, a rejection, a tentative rejection, or a tentative acceptance of the calendar invite 302.

The calendar invite 302 can also delegate authority to the moderators 312 of FIG. 3. The moderators 312 have authority to modify the calendar invite 302. The moderators 312 can be included as part of the participants 206 for the calendar invite 302. The moderators 312 can be excluded as the participants 206 in the calendar invite 302.

The calendar application 204, the invitation creation module 1006, or a combination thereof can generate the calendar invite 302 with a delegation of authority to the moderators 312 in a number of ways. For example, the moderators 312 can include broad authority to modify any information as part of the calendar invite 302. Also as example, the moderators 312 can include limited or restricted authority to modify only certain information in the calendar invite 302. As a further example, the moderators 312 can include different levels of authority between the moderators 312 of the breadth of authority to modify the calendar invite 302. Yet further for example, the moderators 312 can include time varying or conditional authority levels to modify the calendar invite 302. Once the calendar invite 302 has been generated, the flow can progress from the invitation creation module 1006 to the transmission module 1008.

Returning to the description of the transmission module 1008, the transmission module 1008 validate ability to transmit, transmit, or a combination thereof the calendar invite 302 to the participants 206. The calendar application 204, the transmission module 1008, or a combination thereof can perform the validation for transmission on a number of aspects of the calendar invite 302.

For example, the transmission module 1008 can validate the availability of the key items 1010, such as location availability based on the time 306 and the date 308 for the calendar event 304. Also for example, the transmission module 1008 can validate the proper format for the phone number 202 for the participants 206 as part of the calendar invite 302.

The calendar application 204, the transmission module 1008, or a combination thereof can validate the calendar invite 302 in a number of ways. For example, the format for the phone number 202 can be validated based on the location of the device invoking the calendar application 204 and to determine if the format for the phone number 202 within the same country, county, region, is formatted for in-country communication. Also for example, the format for the phone number 202 can be validated based on the location of the device invoking the calendar application 204 and to determine if the format for the phone number 202 is for a different country, county, region, is formatted for out of country communication.

When the validation fails, the calendar application 204, the transmission module 1008, or a combination thereof can generate an error message and the flow can return to the event formation module 1002 for possible correction to the calendar invite 302 as a whole. As a different example, the calendar application 204, the transmission module 1008, or a combination thereof can also continue the monitor module 810 for the participants 206 where the validation was successful.

For successful validation, the calendar application 204, the transmission module 1008, or a combination thereof can transmit the calendar invite 302 in a number of ways. For example, the calendar invite 302 can be transmitted by short messaging service (SMS) to the phone number 202 of the participants 206. The phone number 202 can be a new number not previously available to the calendar application 204 prior to generating the calendar invite 302.

It has been discovered that the calendar application 204 can reliably generate the calendar event 304 with minimum information. The calendar application 204 can generate the calendar event 304 based on the phone number 202 that is newly acquired. The use of the phone number 202 not in the contact list 920 or the electronic mail address 914 allows for minimum information to invite the participants 206 associated with the phone number 202. Further, the use of the phone number 202 solely to generate the calendar invite 302 eliminates potential errors for the misspelling of the name or the electronic mail address 914.

As a further example, the calendar invite 302 can be transmitted by text messaging applications associated with the phone number 202 of the participants 206. The text messaging applications can include programs utilizing the phone number 202 such as Line™, KakaoTalk™, Whatsapp™, Facebook Messanger™, or a combination thereof. As a further example, the transmission module 1008 can also optionally transmit the calendar invite 302 to the electronic mail address 914 of the participants 206.

The transmission module 1008 can also transmit the calendar invite 302 by generating a link to a URL. The link to the URL can be posted to allow access to the calendar invite 302. The link to the URL can be posted on website and social media. Once the calendar invite 302 has been transmitted, the electronic system 100 can continue the operation of the calendar application 204. The flow can progress from the invite module 808 to the monitor module 810.

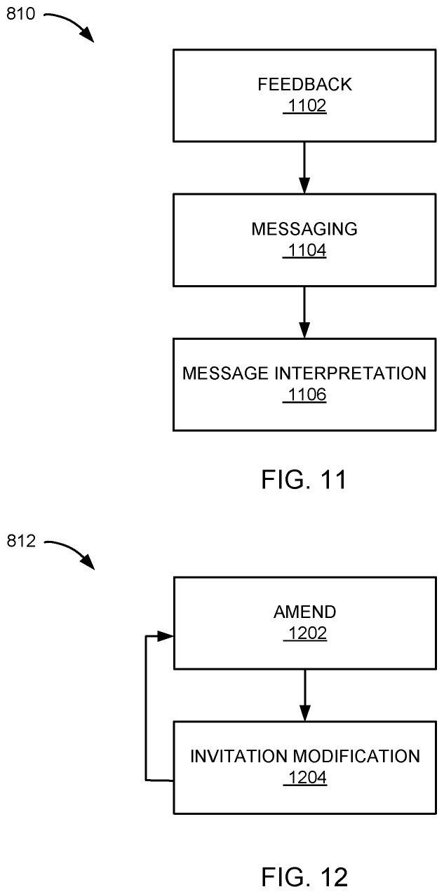

Referring now to FIG. 11, therein is shown the control flow for the monitor module 810 in an embodiment. The monitor module 810 tracks any of the calendar invite 302 of FIG. 3 generated or received by the calendar application 204 of FIG. 2.

As an example, the monitor module 810 can include a feedback module 1102, a messaging module 1104, and a message interpretation module 1106. The feedback module 1102 determines the status 602 of FIG. 6 of the participants 206 of FIG. 3. The messaging module 1104 operates of the message board 402 of FIG. 4. The message interpretation module 1106 processes the message 404 of FIG. 4 in the message board 402.

Returning to the description of the feedback module 1102, the feedback module 1102 can determine the status 602 of FIG. 6 of the participants 206. The feedback module 1102 can determine the status 602 of the participants 206 in a number of ways. For example, the status 602 can determine and display a transmission progress of the calendar invite 302. Also for example, the status 602 can include an indication or a display of a successful and a failed transmission of the calendar invite 302 to the phone number 202 of FIG. 2 of the participants 206. As a further example, the status 602 can display and indicate the response 510 of FIG. 5 received from the participants 206. Yet further for example, the status 602 can display and indicate a change in the response 510 from the participants 206. As a further example, the status 602 can display and indicate when there is a lack of the response 510 from the participants 206 who have yet to respond to the calendar invite 302. Once the status 602 of the participants 206 is determined, the flow can progress from the feedback module 1102 to the messaging module 1104.

Returning to the description of the messaging module 1104, the messaging module 1104 operates the message board 402 associated with the calendar invite 302. The messaging module 1104 can operate the message board 402 in a number of ways. For example, the messaging module 1104 can allow the participants 206 to interact with the message board 402 and write the message 404 on the message board 402. Also for example, the messaging module 1104 can display the message 404 from the participants 206 in the message board 402. Further for example, the calendar application 204, the messaging module 1104, or a combination thereof can post the message 404 on the message board 402 for the participants 206. The message 404 can include the update 1014 of FIG. 10 or changes or other notes relating to the calendar invite 302, the calendar event 304 of FIG. 3, or a combination thereof. Yet further for example, the messaging module 1104 can include the message 404 regarding the addition and removal of the participants 206 based on the status 602 of the participants 206.

Continuing with the messaging module 1104, the messaging module 1104 can generate and display the unread number 508 of FIG. 5 of the message 404 for one of the participants 206 for the calendar invite 302. The unread number 508 is a numerical display for the number of the message 404 not yet read or viewed by the instance of the participants 206 viewing in the calendar application 204. The flow can progress from the messaging module 1104 to the message interpretation module 1106.

Returning to the description of the message interpretation module 1106, the message interpretation module 1106 processes the message 404 in the message board 402. The message interpretation module 1106 can process the message 404 in the message board 402 in a number of ways.

For example, the calendar application 204, the message interpretation module 1106, or a combination thereof can utilize natural language processing to interpret information from the message board 402, the message 404, or a combination thereof. The natural language processing can detect the new phone number 916 of FIG. 9, the secondary phone number 918 of FIG. 9, or a combination thereof for the participants 206. Also for example, the calendar application 204, the message interpretation module 1106, or a combination thereof can perform simple word match searching for keywords, such as names of the participants 206, format and string of characters representing the phone number 202, the response 510, or a combination thereof.

Yet further for example, the calendar application 204, the message interpretation module 1106, or a combination thereof can utilize natural language processing to detect invitees for the calendar invite 302. The invitees are persons, a group of persons, entities, or a combination thereof that have not been designated as the participants 206 to the calendar invite 302.

As a further example, the message interpretation module 1106 can utilize natural language processing to infer the status 602 for the participants 206. The calendar application 204, the message interpretation module 1106, or a combination thereof can determine which of the participants 206 are included in the message board 402. The message interpretation module 1106 can determine the participants 206 to be included in the message board 402 based on the status 602 of the participants 206. For example, the message interpretation module 1106 can remove the participants 206 when the transmission of the calendar invite 302 had failed. As a further example, the message interpretation module 1106 can remove the participants 206 who rejected the calendar invite 302. When the changes are detected on the message board 402, the flow can flow to the update module 812 of FIG. 8.

Referring now to FIG. 12, therein is shown the control flow for the update module 812 in an embodiment. As an example, the update module 812 can include an amend module 1202 and an invitation modification module 1204. The amend module 1202 determines whether the update 1014 of FIG. 10 to the calendar invite 302 of FIG. 3 is needed. The update 1014 is a refresh of the calendar invite 302. The invitation modification module 1204 performs the modification of the calendar invite 302.

The amend module 1202 can determine whether the update 1014 is needed in a number of ways. For example, the amend module 1202 can determine the update 1014 if the number of the participants 206 of FIG. 3 available is zero or below a threshold based on the response 510 of FIG. 5 from the participants 206, from the message interpretation module 1106 of FIG. 11 determining the non-availability of some of the participants 206 from the message board 402 of FIG. 4, or a combination thereof.

As a specific example, the threshold can represent a number of minimum number of the participants 206 to proceed with the calendar event 304 of FIG. 3 for the calendar invite 302. As another specific example, the threshold can refer to the participants 206 with delegated authority or the moderators 312 of FIG. 3 or any particular group of the participants 206. In this example with the threshold, the participants 206 or selected members of the participants 206 can be considered as at least part of the key items 1010 of FIG. 10. Also for example, the amend module 1202 can determine whether the update 1014 is needed when at least one of the participants 206 as the key items 1010 did not accept or rejected the calendar invite 302.

As a further example, the amend module 1202 can determine the update 1014 is needed based on at least one of the key items 1010 other than the participants 206 for the calendar event 304, the calendar invite 302, or a combination there is not available. As a specific example, the calendar invite 302 can include the location 310 of FIG. 3 as one of the key items 1010. When the location 310 is no longer available, the calendar application 204 of FIG. 2, the update module 812, the amend module 1202, or a combination thereof can determine that the update 1014 would be needed.

When the calendar application 204, the update module 812, the amend module 1202, or a combination thereof determines the update 1014 is available to modify the calendar invite 302, the status 602 of FIG. 6 can also be modified to reflect the potential or actual modification based on the update 1014. The calendar application 204, the update module 812, the amend module 1202

For illustrative purposes, the calendar application 204 is described as the update 1014 and the status 602 as being distinct and the sequential, although it is understood that the calendar application 204 can operate differently. For example, the calendar application 204, the update module 812, the amend module 1202, or a combination thereof can receive a modification for the status 602 from the message interpretation module 1106 for changes to the phone number 202 of FIG. 2 or for rejections for at least one of the participants 206 identified as one of the key items 1010. The change in the status 602 can trigger the update 1014 as opposed modification to the update 1014 to trigger the modification to the status 602. As another example, the status 602 can be modified after the update 1014 is determined to be needed and occur elsewhere in the control flow for the calendar application 204.

When the amend module 1202 determines the update 1014 is needed, the flow can progress to the invitation modification module 1204. When the amend module 1202 determines the update 1014 is not needed, the flow can progress to the event module 814 of FIG. 8.

The invitation modification module 1204 modifies the calendar invite 302. The invitation modification module 1204 can modify the calendar invite 302 with the update 1014 in a number of ways. For example, the invitation modification module 1204 can modify the calendar invite 302 automatically based on the update 1014. Also for example, the invitation modification module 1204 can modify the calendar invite 302 after the moderators 312 approved the update 1014 in the calendar application 204. Further for example, the calendar application 204, the update module 812, the invitation modification module 1204, or a combination thereof can modify the calendar invite 302 with the update 1014 based on the trigger or criteria set by the moderators 312. When the calendar invite 302 has been modified with the update 1014, the flow can progress to the event module 814.

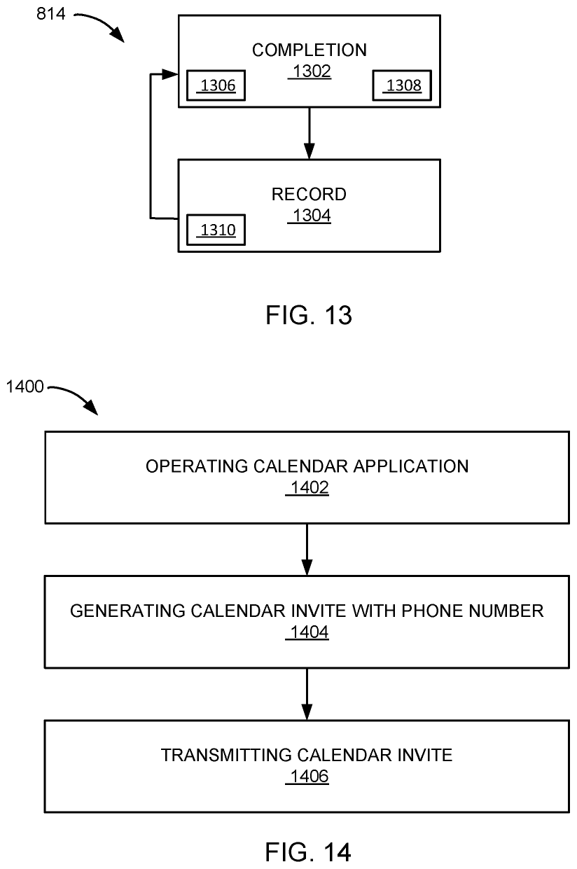

Referring now to FIG. 13, therein is shown the control flow for the event module 814 in an embodiment. As an example, the event module 814 can include a completion module 1302 and a record module 1304. The completion module 1302 determines an occurrence 1306 or an expiration 1308 of the calendar event 304 of FIG. 3 of the calendar invite 302 of FIG. 3. The record module 1304 captures of a record 1310 associated with the calendar event 304.

Returning to the description of the completion module 1302, the calendar application 204, the event module 814, the completion module 1302, or a combination thereof determines the occurrence 1306 or the expiration 1308 of the calendar event 304 in the calendar invite 302. The occurrence 1306 refers to the calendar event 304 proceeding. The expiration 1308 refers to the calendar event 304 to be no longer proceed.

The completion module 1302 can determine the occurrence 1306 of the calendar event 304 in a number of ways. For example, the completion module 1302 can determine the occurrence 1306 based on none of the key items 1010 of FIG. 10 where not available for the calendar event 304. As a specific example, the key items 1010 can refer to the attendance of the participants 206 of FIG. 3 there are identified as the key items 1010 as well as other attributes of the calendar invite 302 identified as the key items 1010 being available for the calendar event 304.

As another example, the completion module 1302 can also determine the occurrence 1306 based on the time 306 of FIG. 3, the date 308 of FIG. 3, and the combination thereof has passed without the status 602 of FIG. 6, the update 1014 of FIG. 10, or the combination thereof invoking a modification to the calendar invite 302, the calendar event 304, or a combination thereof. As a further example, the completion module 1302 can determine the occurrence 1306 based on the moderators 312 of FIG. 3 with the authorization to modify the calendar invite 302 did not take action to change the calendar invite 302, the calendar event 304, or a combination thereof. Yet further for example, the occurrence 1306 of the calendar event 304 can be determined by or in conjunction with the status 602, the update 1014 of FIG. 10, or a combination thereof.

Returning to the determination of the expiration 1308, the calendar application 204 of FIG. 2, the event module 814, the completion module 1302, or a combination thereof can determine the expiration 1308 of the calendar event 304 in a number of ways. For example, the determination for the expiration 1308 can be triggered by the lack of the response 510 of FIG. 5 from the participants 206 of FIG. 3 or a sufficient number of the participants 206. As a specific example, the determination for the expiration 1308 can be triggered by the lack of the response 510 by at least one of the participants 206 identified as one of the key items 1010 in the calendar invite 302, the calendar event 304, or a combination thereof. Also as a specific example, the determination for the expiration 1308 can be triggered by attributes as the key items 1010, other than the participants 206, which are not available for the calendar event 304. The non-availability and the lack of the response 510 can be based on some time or other triggers prior to the time 306, the date 308, or a combination thereof of the calendar event 304 and not necessarily on or past the time 306, the date 308, or a combination thereof of the calendar event 304.

Also for example, the determination of the expiration 1308 can be determine by rescheduling the calendar event 304 in the calendar invite 302. An earlier version of the calendar invite 302 for an earlier version of the calendar event 304 that has been rescheduled can indicate the earlier version with the expiration 1308. Further for example, the cancellation of the calendar event 304, the calendar invite 302, or a combination thereof can also lead to the determination of the expiration 1308. Yet further for example, the expiration 1308 of the calendar event 304 can be determined by or in conjunction with the status 602, the update 1014, or a combination thereof.

When the determination of the expiration 1308 has been generated, the flow can progress to the calendar application 204 to resume for continued operation or terminate operation of the calendar application 204. When the determination of the occurrence 1306 has been generated, the flow can progress to the record module 1304, the calendar application 204 to resume for continued operation, or terminate operation of the calendar application 204.

Returning to the description of the record module 1304, the record module 1304 can detect or capture the record 1310 of the calendar event 304. The record 1310 can represent information regarding the calendar event 304 before, during, after or a combination the calendar event 304. The information in the record 1310 can be stamped with the time 306, the date 308, or a combination thereof. The information in the record 1310 can also be associated with the geography location of when that particular information was captured.

As examples, the record 1310 can include text, symbols, still imagines, audios, videos, multi-media, URL links, or a combination thereof. The record 1310 can represent information leading up to the calendar event 304 or regarding information or relating to the calendar invite 302. The record 1310 can also represent information during the calendar event 304. The record 1310 can further represent information after the calendar event 304 but associated with the calendar event 304, the calendar invite 302, or a combination thereof.

The calendar application 204, the event module 814, the record module 1304, or a combination thereof can organize the information in the record 1310 in a number of ways. For example, the record 1310 can be organized based on sequential timing or time slots, such as before, during, or after the occurrence 1306 of the calendar event 304. Also for example, the record 1310 can be based on categories or affinities, such as the information for setting up the calendar event 304, the participants 206 or selected groups, the moderators 312, the key items 1010, outcome and actions during the calendar event 304, or a combination thereof.

The record module 1304 can also optionally modify the calendar invite 302 after the occurrence 1306 of the calendar event 304 to share at least some of the record 1310 to the participants 206. The record module 1304 can share the record in a number for ways. For example, the calendar application 204, the event module 814, the record module 1304, or a combination thereof can share the entirety of the record 1310 to the participants 206 who attended the calendar event 304. Also for example, the record 1310 can be share in a limited or restricted manner. As a specific example, the record 1310 can be shared to the moderators 312 identified in the calendar application 204. As another specific example, the record 1310 can be shared based on the location 310 of FIG. 3 relative to the participants 206 or those directly associated with the participants 206, such as a photo including a picture of the participants 206.

The calendar application 204, the event module 814, the record module 1304, or a combination thereof can invoke the capturing mechanism within the calendar application 204. The invocation can be by voice command, gestures, activation icons, or a combination thereof. The capturing mechanism can include the first user interface 718 of FIG. 7, the second user interface 738 of FIG. 7, or a combination thereof.

The calendar application 204, the event module 814, the record module 1304, or a combination thereof can also receive information about the calendar event 304 to be included in the record 1310. Information can be included in the record 1310 in a number of ways. For example, the calendar application 204, the event module 814, the record module 1304, or a combination thereof can retrieve information for the record 1310 by searching the Internet or gather information from URL links. Also for example, the participants 206 who attended the calendar event 304 can send or submit information, such as pictures, videos, documents, relating to the calendar event 304 through the calendar application 204 for the calendar event 304. The calendar invite 302 can include a URL link or information for submitting the information.

Referring now to FIG. 14, therein is shown a flow chart of a method 1400 of operation of an electronic system 100 in an embodiment of the present invention. The method 1400 includes: operating a calendar application in a box 1402; generating a calendar invite with a phone number in a box 1404; and transmitting the calendar invite with the phone number in a box 1406.

The physical transformation generated by the electronic system 100, the calendar application 204 of FIG. 2, or a combination thereof includes the movement of the participants 206 of FIG. 2 along with other apparatus required to effectuate the movement and the response 510 of FIG. 5 as a result of the calendar invite 302 of FIG. 3 generated by the calendar application 204. The actions or movement in the real world by the participants 206 and attendant other actions in the real world also affects the operation and function of the electronic system 100, the calendar application 204, or a combination thereof as described throughout above.

The resulting method, process, apparatus, device, product, and system is straightforward, cost-effective, uncomplicated, highly versatile, accurate, sensitive, and effective, and can be implemented by adapting known components for ready, efficient, and economical manufacturing, application, and utilization.

Another important aspect of the present invention is that it valuably supports and services the historical trend of reducing costs, simplifying systems, and increasing performance.

These and other valuable aspects of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters hithertofore set forth herein or shown in the accompanying drawings are to be interpreted in an illustrative and non-limiting sense.

What is claimed is:

1. A method of operation of an electronic system comprising:
operating a calendar application;
generating a calendar invite with a phone number; and
transmitting the calendar invite with the phone number.

2. The method as claimed in claim 1 wherein generating the calendar invite with the phone number includes generating the calendar invite with the phone number not in a contact list.

3. The method as claimed in claim 1 wherein generating the calendar invite includes generating the calendar invite without an electronic mail address.

4. The method as claimed in claim 1 wherein generating the calendar invite includes generating a message board included in the calendar invite.

5. The method as claimed in claim 1 further comprising generating a view in the calendar application with the view displaying an unread number of a message associated with the calendar invite.

6. The method as claimed in claim 1 wherein:
generating the calendar invite includes generating a message board included in the calendar invite;
further comprising:
detecting a new phone number from the message board; and
modifying the calendar invite with the new phone number.

7. The method as claimed in claim 1 further comprising:
detecting a status of the phone number for the calendar invite; and
determining an update to the calendar invite based on the status.

8. A electronic system comprising:
a control circuit configured to:
operate a calendar application;
generate a calendar invite with a phone number;
transmit the calendar invite with the phone number; and
a communication circuit, coupled to the control circuit, configured to:
transmit the calendar invite with the phone number.

9. The system as claimed in claim 8 wherein the control circuit is further configured to generate the calendar invite with the phone number not in the contact list.

10. The system as claimed in claim 8 wherein the control circuit is further configured to generate the calendar invite without an electronic mail address.

11. The system as claimed in claim 8 wherein the control circuit is further configured to generate a message board included in the calendar invite.

12. The system as claimed in claim 8 wherein the control circuit is further configured to generate a view in the calendar application with the view displaying the unread number of a message associated with the calendar invite.

13. The system as claimed in claim 8 wherein the control circuit is further configured to:
generate a message board included in the calendar invite;
detect a new phone number from the message board; and
modify the calendar invite with the new phone number.

14. The system as claimed in claim 8 wherein the control circuit is further configured to:
detect a status of the phone number for the calendar invite; and
determine an update to the calendar invite based on the status.

15. A non-transitory computer readable medium including instructions executable by a control circuit for an electronic system comprising:
operating a calendar application;
generating a calendar invite with a phone number; and
transmitting the calendar invite with the phone number.

16. The non-transitory computer readable medium as claim in claim 15 wherein generating the calendar invite with the phone number includes generating the calendar invite with the phone number not in a contact list

17. The non-transitory computer readable medium as claim in claim 15 wherein generating the calendar invite includes generating the calendar invite without an electronic mail address.

18. The non-transitory computer readable medium as claim in claim 15 wherein generating the calendar invite includes generating a message board included in the calendar invite.

19. The non-transitory computer readable medium as claim in claim 15 further comprising generating a view in the calendar application with the view displaying an unread number of a message associated with the calendar invite.

20. The non-transitory computer readable medium as claim in claim 15 wherein:
generating the calendar invite includes generating a message board included in the calendar invite;
further comprising:
detecting a new phone number from the message board; and
modifying the calendar invite with the new phone number.
